(19) United States
(12) Patent Application Publication
(10) Pub. No.: US 2011/0320981 A1
(43) Pub. Date: Dec. 29, 2011

(54) STATUS-ORIENTED MOBILE DEVICE

(75) Inventors: Guobin Shen, Beijing (CN); Min Wang, Beijing (CN)

(73) Assignee: Microsoft Corporation, Redmond, WA (US)

(21) Appl. No.: 12/821,390

(22) Filed: Jun. 23, 2010

(51) Int. Cl. G06F 3/048; G06F 15/16

(52) U.S. Cl. 715/834; 709/224

(57) ABSTRACT

One or more techniques and/or systems are disclosed for providing a status-oriented mobile device. A user interface (UI) is provided that concurrently presents a plurality of user-related status-oriented sections in a display of the mobile device. The respective status-oriented sections are provided to be organized in a cylindrical representation as a cylinder, where the UI presents elements of the sections in the display as views of the cylinder.

### BACKGROUND

Mobile devices can comprise a plurality of advanced capabilities, often with personal computer like functionality. Mobile devices often combine a mobile phone with an operating system that enables a user to operate many applications, connect to the Internet, and stay updated with information, such as news, connection status, etc. Use of mobile devices is practically ubiquitous, and some users utilize their mobile devices as mobile work stations, conducting meetings, collecting and sending information (e.g., email), and working on applications. Further, some users utilize their mobile devices to stay up-to-date with theirs and their connection's social status, such as by micro-blogging, texting, emailing people in the social network.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Mobile phones have been designed to enable a user to communicate anywhere. Currently, they have evolved as a primary tool for a user to get connected to friends, colleagues, relatives and the world, and to connect to the Internet (e.g., for information, status updates, etc.). In order to accommodate users' desires, many applications (apps) have been developed for use on mobile devices. For example, websites offers thousands of apps that can be uploaded to mobile devices. However, most apps are for specific purposes and users typically have to operate many applications to perform a single task.

For example, a user may have contact in different online social networks, and other contact connections. In this example, if the user wishes to know a status of all their contact, they may have to operate each of the appropriate apps to receive and perform updates. As another example, when a user goes to a new location (e.g., arrives in a city), they may wish to perform an explicit search to obtain desired information, such as nearby points of interest (POIs) (e.g., restaurants, tourist spots, venues, etc.), and may be required to search several locations online to find the desired information.

As provided herein, one or more techniques and/or systems are disclosed that provide for a user interface (UI) that can enable a user to remain updated about their current status, for example, and obtain an up-to-date status at a glance by providing several status-oriented sections on the display at the same time. A plurality of user-related status-oriented information can be aggregated and displayed in a UI, such as by displaying several different status-oriented information types (e.g., social, location, events, etc.)

In one embodiment for providing a status-oriented mobile device, a user interface (UI) is provided that enables concurrent presentation of a plurality of user-related status-oriented sections in a display of the mobile device, such as the user's location status, social-network status, personal status, and event status. Further, the respective status-oriented sections can be organized in a cylindrical representation as a cylinder, where the UI presents elements of the sections in the display as views of the cylinder, for example, thereby providing a logical arrangement of aggregated status information for quick retrieval and interaction.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for providing a status-oriented mobile device.

FIG. 2 is an illustration of an exemplary interface where a plurality of user-related status-oriented sections are displayed.

FIG. 3 is a component diagram illustrating exemplary arrangements for a cylinder representation of information.

FIGS. 4A and 4B are illustrations of example cylinder views.

FIGS. 5A and 5B illustrate an example of displays of a social hub section.

FIGS. 6A and 6B illustrate an exemplary embodiment of a location hub section.

FIGS. 7A and 7B illustrate example embodiments of a self hub section display.

FIG. 8 is a component diagram illustrating an example system for providing a status-oriented mobile device.

FIG. 9 illustrates one example embodiment of an implementation of one or more aspects of a system described herein.

FIG. 10 is an illustration of an exemplary computer-readable medium comprising processor-executable instructions configured to embody one or more of the provisions set forth herein.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

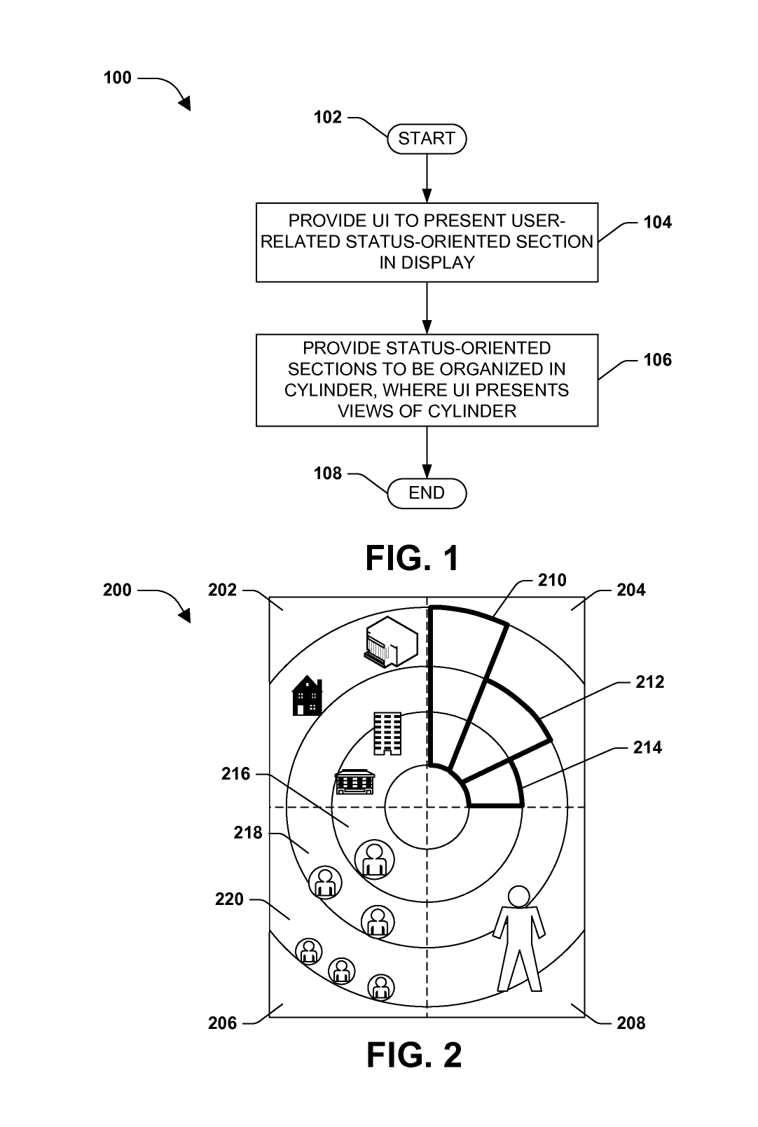

FIG. 1 is a flow diagram of an exemplary method 100 for providing a status-oriented mobile device. The exemplary method 100 begins at 102 and involves providing for a user interface (UI) to concurrently present a plurality of user-related status-oriented sections in a display of the mobile device, at 104. For example, instead of providing a group of applications (apps) that a user can manipulate, the UI can provides status-based information, which may combine information from a plurality of apps.

In one aspect, mobile phones were designed to enable a user to communicate anywhere. They have evolved as a primary tool for a user to get connected to the world and the Internet. In order to accommodate users' desire for different kinds of information, many apps have been developed for use on mobile devices. However, as most apps are for specific purposes, users typically have to operate many applications in order to get a desired understanding their context. For example, a user may have friends in different social networks such as Facebook, Twitter, MSN, GTalk, etc. In this example, if the user wishes to know a status of all their friends, they may have to operate each of the appropriate apps. As another example, when a user goes to a new location, they may wish to perform an explicit search to obtain desired information, such as nearby points of interest (POIs) (e.g., restaurants, tourist spots, venues, etc.).

In one embodiment, the UI can enable a user to remain updated about their current status, for example, and obtain an up-to-date status at a glance by providing several status-oriented sections on the display at the same time. FIG. 2 is an illustration of an exemplary interface 200 where a plurality of user-related status-oriented sections are displayed. In this embodiment, the interface 200 is divided into four sections 202, 204, 206, 208.

A location hub section 202 can organize user-related location status information, such as where the user is geographically located and what is located near the user. A social hub section 206 can organize user-related social network status information, such as by applying information from one or more social networks (e.g., combining information from several different social network sources) in the display. An event hub section 204 can organize user-related events status information, such as calendar items, task items, and others that are time sensitive (e.g., or location and/or people sensitive) for example. A self-status hub section 208 can organize user-related personal status information, such as health and environmental items.

Returning to FIG. 1, at 106 in the exemplary method 100, the respective status-oriented sections are organized in a cylindrical representation as a cylinder, where the UI presents elements of the sections in the display as views of the cylinder. For example, the status related items in the respective sections can be organized as a cylinder, and viewing the items can entail viewing parts of the cylinder.

As an example, as illustrated in the example interface 200 of FIG. 2, the social hub section 206 can be organized such that different rings of the cylinder can comprise different information. For example, ring 216 may provide status information for a first group of contacts (e.g., friends), where rings 218 and 220 may provide status information for a second and third group of contacts (e.g., colleagues, clients). As another example, the event hub section 204 can be organized such that different rings of the cylinder represent importance or an event, and/or timing for the event, or even a type of event. For example, the event 210 may be a next event on a calendar, followed by the events 212 and 214, thereby showing different levels in the cylinder. As another example, event 210 may be more important to the user than the other events, or may comprise more time.

Having provided or the sections to be organized as a cylinder, the exemplary method 100 ends at 108.

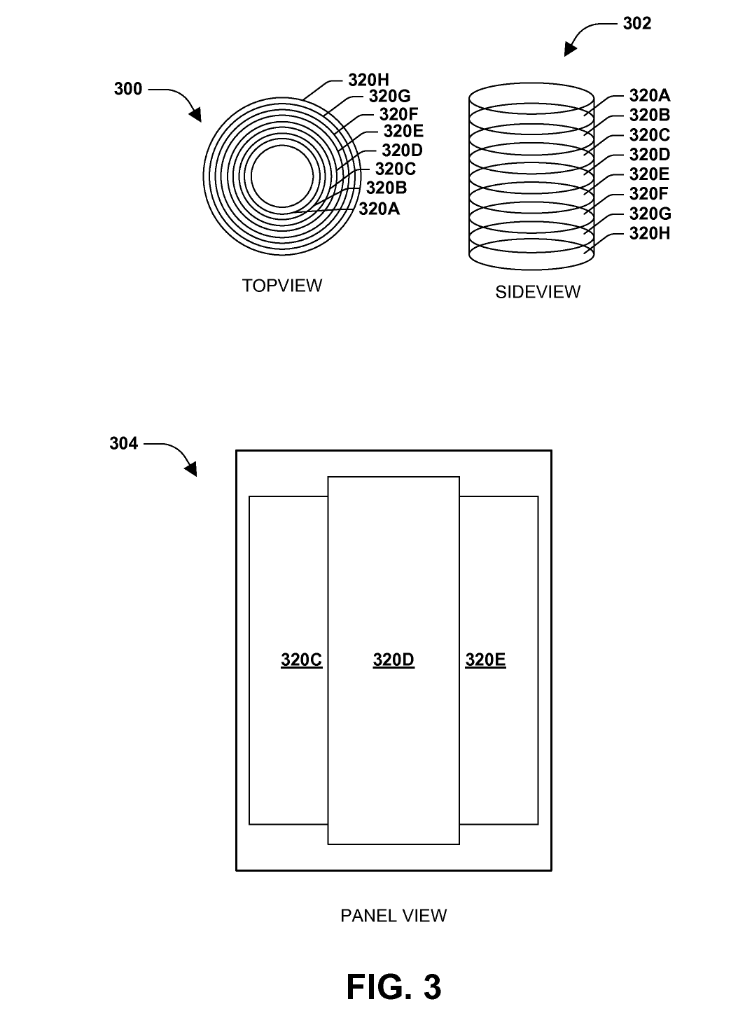

FIG. 3 is a component diagram illustrating exemplary arrangements for a cylinder representation of information. A topview 300 of a cylinder illustrates one example view of information stored in a cylinder representation. In one embodiment, the topview 300 may comprise a view of cylinder sections 320A-H that are stacked (e.g., or concentrically arranged), where a portion of a section viewed from the topview comprises merely a portion of the information stored in the cylinder section. In this view 300, the cylinder sections are arranged as concentric circles merely for ease of viewing, where the respective section have a common relationship (e.g., days, locations, etc.). In this way, in this example, several sections of information may be viewed at a glance, and if desired, a user may select a cylinder section for a more detailed view.

A sideview 302 of a cylinder illustrates another view of how information may be arranged. In this example 302, the sections 320A-H are stacked, where respective section may display a portion of the information organized by a section. As an example, the cylinder sections are displayed as stacked disks that have a common relationship with each other. In this way, as an example, a user may select a cylinder section for a more detailed view of the information arranged therein.

A panel view 304 (e.g., side view, with side panels), illustrates and example of a more detailed view of a cylinder section 320A-H. As an example, the user may select cylinder section 320D from either the topview 300 or sideview 320. Upon selection, for example, the panel view can show a detailed view of the information organized therein. Further, in one embodiment, adjacent sections 320C, 320E may be displayed for reference, and/or esthetic purposes, for example.

In one embodiment, organizing the event status information in the cylinder can comprise organizing the information such that a distance from center of the cylinder represents a function of time from a current time. That is, as shown in the example 300, cylinder section 320A may represent information that is closer to the current time (e.g., representing the current day), where cylinder 320B can represent information from a later time (e.g., the next day). In this way, information about event-status from different times can be aggregated in the event hub section, for example, providing quick reference for a user (e.g., as is hub section 204 of FIG. 2).

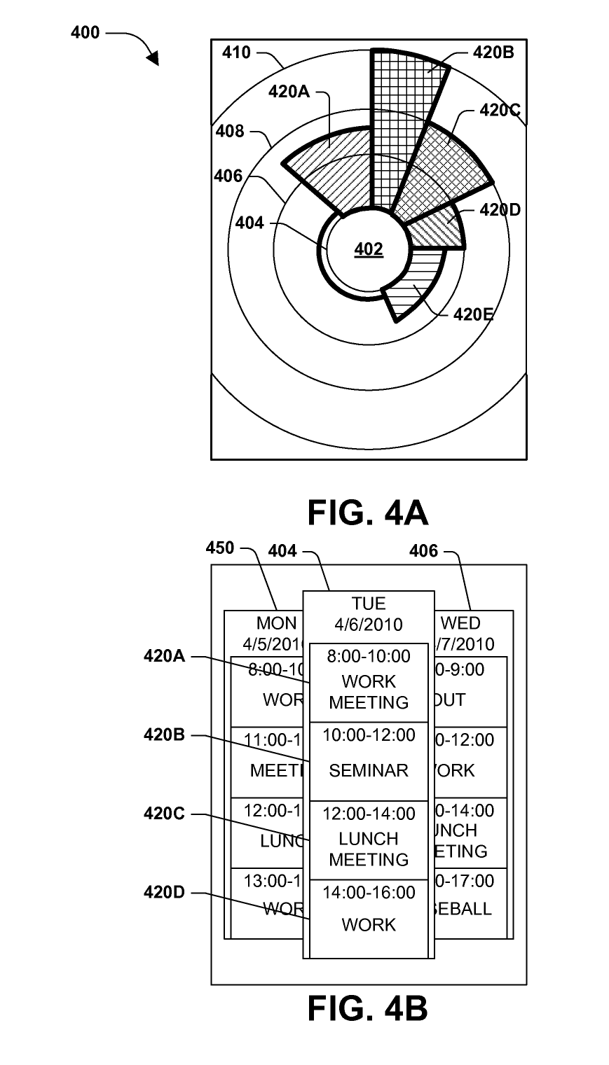

FIGS. 4A and 4B are illustrations of example cylinder views. In one embodiment, a time-based calendar system may be used to coordinate with the event hub. In this embodiment, in a topview of the event hub 400, respective cylinder sections 404, 406, 408, 410 can comprise different time slices, such as days, weeks, or months. Further, as an example, the center of the cylinder 402 may comprise a current time, such as illustrated by a clock. In this way, for example, a view of current and future events may be available on a display for quick reference.

As shown in FIG. 4A, a series of events 420A-E associated with the cylinder section 404 can be displayed in a topview, for example. Further, as illustrated in FIG. 2, a portion of the event hub 204 can be shown in the aggregated view, comprising the events 210-214 corresponding to a current day, for example. Additionally, as shown in FIG. 4B, if a user selects a cylinder section (e.g., 404), a panel view can be shown. In this example, the panel view displays cylinder section 404, comprising the events 420A-D that are associated with the day. Further, adjacent cylinder sections 406, 450 can be displayed to give a user perspective, and/or additional information, for example.

As an example, in FIG. 4A, the center cylinder section 402 can comprise a clock, where the time may be 10:00 AM. In this example, a next event comprises the seminar from 10:00 AM to 12:00 PM 420B. Further, as shown in FIG. 4A, the event 420B is displayed as a larger cylinder part than that of the other events 420A, 420C-E. In this example, a user may be able to quickly glance at the display of the mobile device to find out which event is coming next or happening at the particular time.

In one embodiment, events from a plurality of sources and applications may be aggregated to provide user-related, status-oriented information for events. For example, information from one or more calendars may be aggregated, such as from a work calendar and an Internet-based personal calendar. Further, events can be aggregated from social networks, and/or added by contacts with permission.

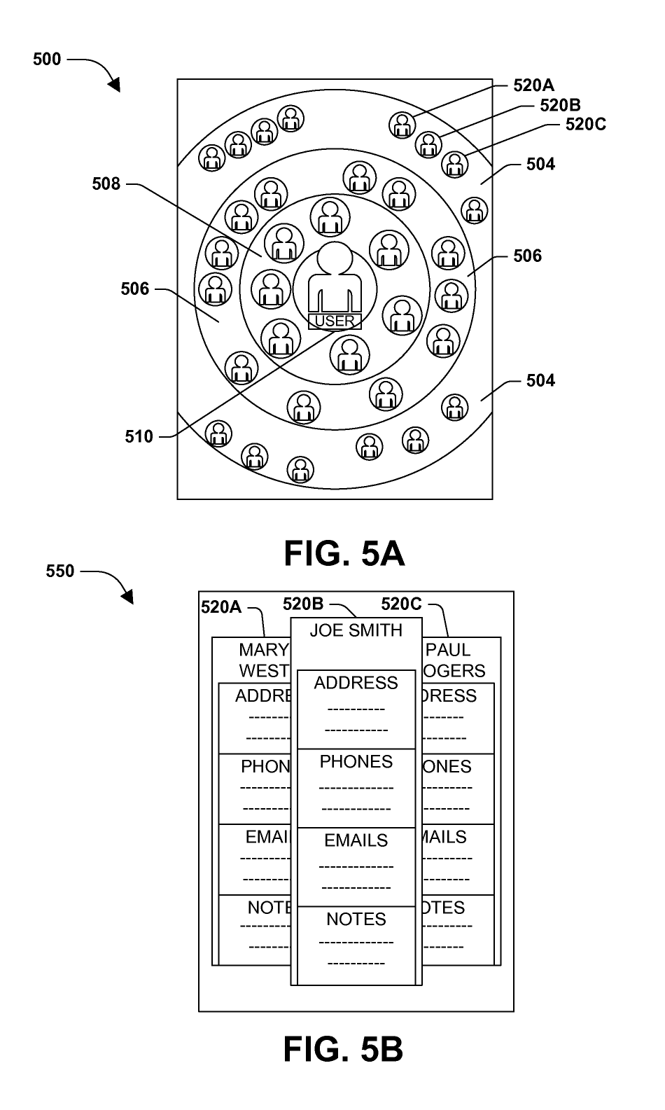

In one embodiment, organizing the social hub section can comprise organizing the social network status information in the cylinder where a distance from a center of the cylinder represents a function of a time between a last user social network update and a current time. FIGS. 5A and 5B illustrate an example of displays 500, 550 of a social hub section. In this example, the displayed topview 500 of the social hub section respective cylinder sections 504, 506, 508 may be associated with connections, such as 520A-C that have updated their social status.

For example, those connections in the cylinder section 508 may have updated their status more recently than those in cylinder sections 506 and 504. In this way, for example, the user (e.g., represented in section 510 of 500) may be able to see more recent social status updates at a glance. In one embodiment, the user may then select a connection, such as 520B of FIG. 5, and the display can switch to a panel view as shown in 550 of FIG. 5B. In this way, the user may identify the connection's name, social status, and other information, for example.

In another embodiment, the distance from a center of the cylinder represents a function of a closeness of a relationship between the user and a social contact, or user specified social groups, or various social networking applications. For example, cylinder section 508 may represent those connections that have a closer relationship (e.g., identified by a filter, user supplied details, and/or amount of connection/correspondence) with the user 510 than those found in cylinder section 506 and 508.

As another example, respective cylinder sections 504, 506, 508 may represent different social groups, such as friends, colleagues, and relatives. As another example, respective sections may comprise different social networking applications, such as Facebook, Twitter, and MSN. In one embodiment, a user may be provided with an ability to register various social networks with the social hub, such as by using one or more application programming interfaces (APIs), in order to provide status updates in the social hub. In this way, for example, various social networking statuses can be aggregated on the social hub section, for example, providing the user with an ability to identify social networking status at a glance.

In one embodiment, organizing the location status information in the cylinder can comprise organizing the information such that a distance from a center of the cylinder represents a function of a location status information geographical distance from the user's geographic location. In one embodiment, a status of pre-filtered POIs can be provided in the location hub section, such as based on a location of the mobile device. For example, POI information can be automatically retrieved from an online connection, such as to the Internet, for the POI when the mobile device is within a desired range of the POI (e.g., a preset range, either default or user preferred). As another example, POI information may comprise user filtered information for the POI, such as preset information about a POI provided by the user.

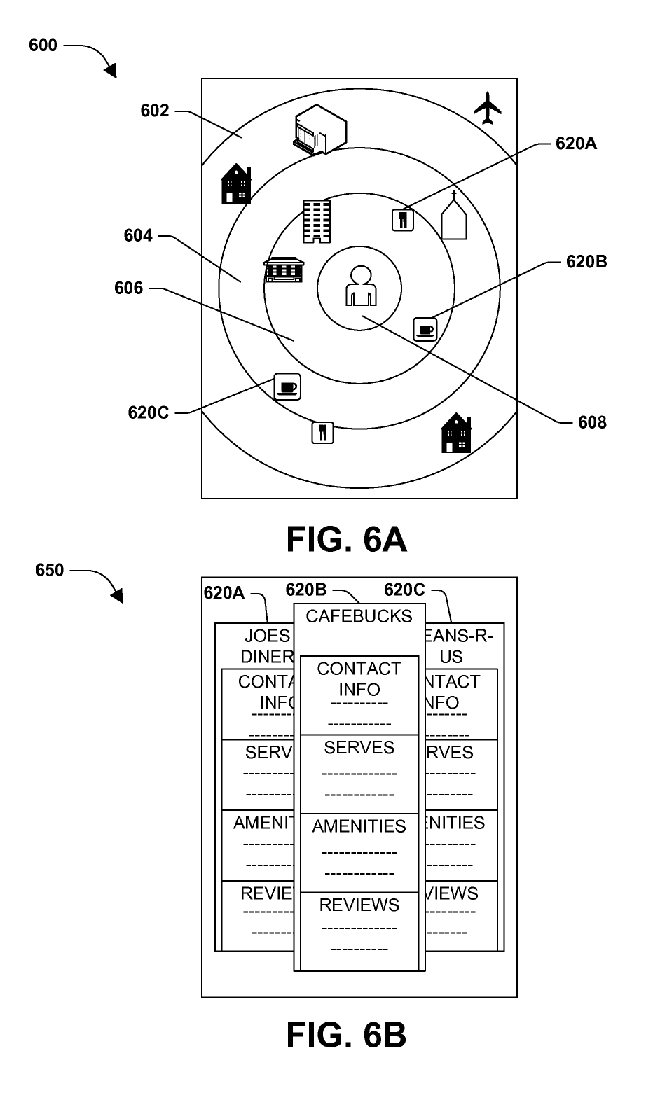

FIGS. 6A and 6B illustrate an exemplary embodiment of a location hub section 600, 650, for example, where information about user-related location status can be aggregated. In the example display 600, the cylinder sections 602, 604, 606 comprise different geographic distances from the user 608. In one embodiment, the location of the user can be determined by a GPS tracker, user information input, and/or mobile device triangulation (e.g., cellular or wireless signal fingerprinting or triangulation, or some other location technique or system, such as installed in a mobile phone). As an example, as the user's location 608 moves, such as around a city, POIs 620A-C may be displayed in the location hub. In this way, for example, POIs user-related status-oriented information can be aggregated for POIs in the display.

As an example, the user may wish to find a place to go and get some coffee while they are traveling in an unknown city. In this example, the user may have set some reference filters concerning types of POIs to show in the location hub section, such as to show places to eat (e.g., 620A-C). In FIG. 6A, as the user's location 608 moves about the city, the POIs that identify potential locations to get a cup of coffee 620A-C can be displayed in the hub 600. Further user may select a particular POI 620B, which can be displayed in a panel view 650. In this view, a further description other information may be displayed for the user. Additionally, the other POIs 620B and 620C that are in a same category of POI can be displayed in panel view 650 for user reference.

In one embodiment, a map may be overlayed in the location hub section to provide the user with a means for navigating around a location. In another embodiment, brief description information may be provided, such as in a pop-up, for the POIs displayed in the location hub section, for example, when the first pop-up, and/or when the user moves a selector over them (e.g., mouses over). In another embodiment, a distance range for the respective cylinder sections 602, 604, 606 may be adjusted by the user to comprise different ranges (e.g., five hundred yards, one thousand yards, etc.) In this way, in this example, the POIs can be displayed when they meet preset criteria of distance from the user location 608.

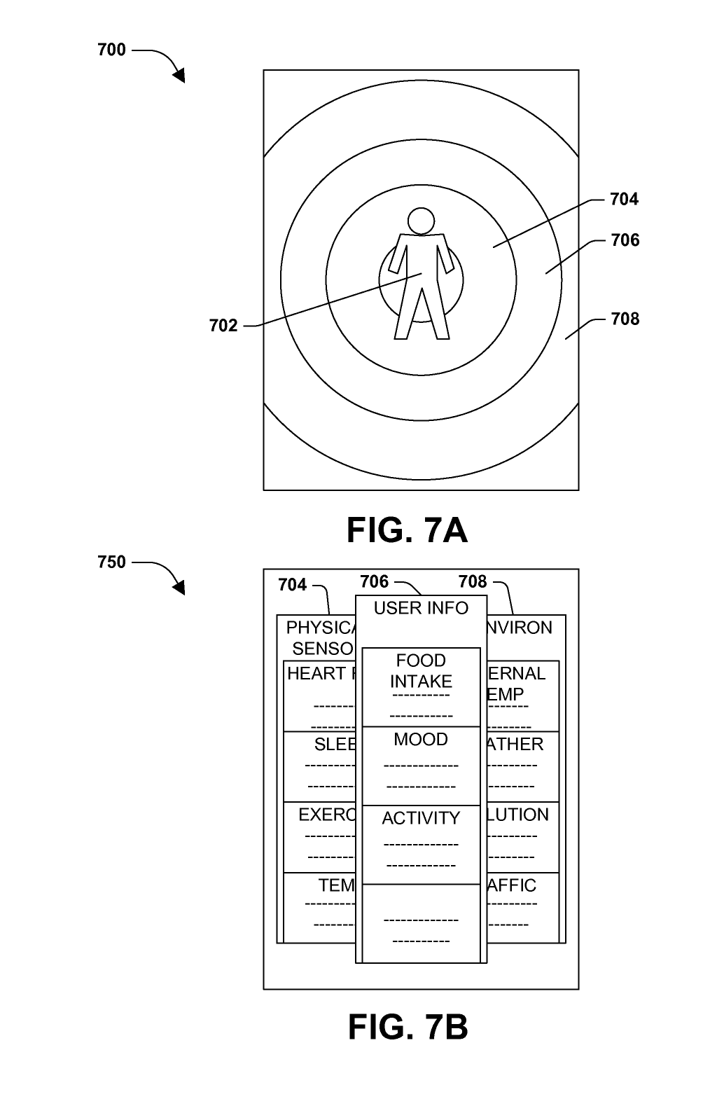

FIGS. 7A and 7B illustrate example embodiments of a self hub section display 700, 750, for example, where information about user-related personal status can be aggregated. In one embodiment, the self hub section may utilize one or more physical sensors to determine user status information. For example, respective cylinder sections 704, 706, 708 may comprise information gathered by one or more physical sensors related to the user 702, and the information can be relayed to the self hub section for display. Further, in one embodiment, some of the information organized by the cylinder section 704, 706, 708 may comprise self-reported information by the user, for example.

As an example, some physical sensors that relay information may comprise a heart rate monitor, a sleep monitor, exercise monitor (e.g., pedometer, accelerometer), temperature monitor, and any others devised to monitoring a person's condition. Further, physical monitors may comprise environmental monitors, such as thermometers, pollution monitor, UV ray monitor, traffic monitor, and any others devised to monitor environmental conditions for a user. Additionally, the user may self-report information, such as food intake, sleep cycles, mood, activity, and any other information the user wishes to monitor and log.

A user may view the aggregated self-related status information in the self hub section by itself, or when the self hub section is one of a plurality of sections displayed (e.g., as in FIG. 2), at a glance to identify desired information. Further user may select one of the cylinder section 704, 706, 708, or a particular item in one of the sections to switch to panel view FIG. 7B. In the panel view, for example, more detailed information can be organized and displayed for the user to view. Additionally, the panels 704, 706, 708 of FIG. 7B can be arranged to provide perspective and help organize the information for the user.

It will be appreciated, that the techniques and/or systems described herein are not limited to the example embodiments described above. It is expected that those skilled in the art may devise alternate user-related status oriented sections to display. For example, a project status hub may be devised that provides the user with status information for projects they are working on. Further, in this example, the project related hub section may be displayed when the user arrives at work (e.g., or changes their status to “at work”). In this example, information for a plurality of projects may be aggregated in the hub.

Further, in one embodiment, developers and/or users may configure new or different status-related hub sections that can be uploaded or loaded to the mobile device. As an example, the user may change or develop and existing hub section on the mobile device that can be displayed along with existing status related hub sections. As another example, a user may upload a status related hub section to the mobile device, such as from the Internet, which was created by a developer for a particular purpose.

In one aspect, the UI can display a plurality of user-related status oriented sections at a same time, and, for example, a user may select a particular hub section to be displayed alone on the display. In one embodiment, the user can select a section or a plurality of hub sections to be displayed, for example, depending on which type of status related information is desired to be aggregated and displayed for convenient viewing. As an example, FIG. 2 illustrates four hub sections displayed, and FIGS. 4A, 5A, 6A, 6A respectively illustrate a view of a single hub section. In one embodiment, the user may select two or more hub sections for display, depending on preference, so that status related information is aggregated in the UI.

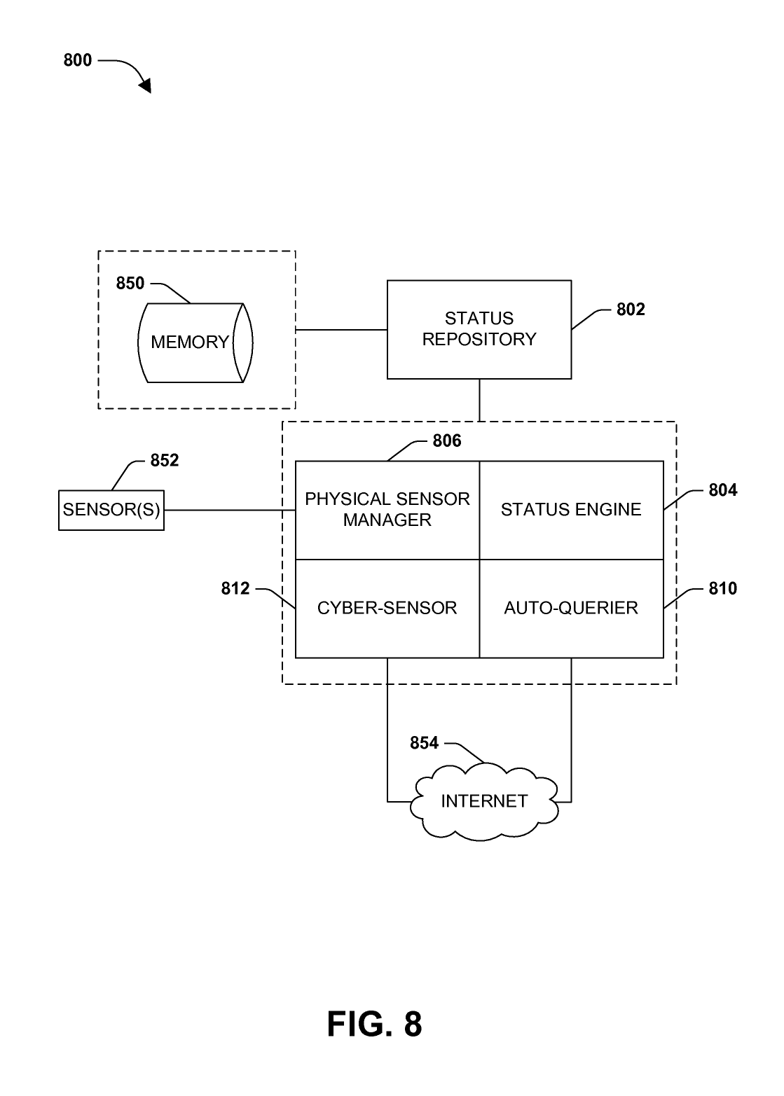

A system may be devised that allows for status-oriented information to be aggregated, for example, creating a status-oriented mobile device instead of an application-oriented mobile device. FIG. 8 is a component diagram illustrating an example system 800 for providing a status-oriented mobile device. A status repository component 802 stores status-related data in a memory component 850 of the mobile device. For example, as user-related status information is updated (e.g., social status, events, self, location), the information can be stored in the status repository component 802.

A status engine 804 is operably coupled with the status repository component 802, and is used to determine a user's current status based on context of user-related status information. For example, a GPS device in the mobile device may indicate that the user is at work, the event status may indicate that the user is in a meeting, the social status may indicate the user is making a presentation at the meeting. In this way, those connections with permission may be notified that the user cannot be contacted by phone or text at this time. As another example, the GPS may indicate that the user is at home, and the self-status may indicate the user is sleeping, the status engine 804 can determine the status for the user based on input from a plurality of context-related information for the user.

A physical sensor management component 806, coupled with a plurality of physical sensors 852 and the status repository component 802, collects physical information from the physical sensors, such as personal sensors (e.g., heart rate monitor), environmental sensor (e.g., thermometer, accelerometer). As an example, the physical sensors may collect how much exercise the user has undertaken, and can report whether the user needs to exercise more or less based on a pre-set filter. As another example, an amount of sleep can be monitored, pollution levels in the area, temperature outside/inside, even physical conditions that may indicate health related concerns.

In one embodiment, the personal physical sensors may indicate a serious health condition when aggregated, and the status engine 804 determines that a health problem exists. As an example, emergency services may be automatically summoned, and/or information reported to the user's doctor. As another example, the mobile device may comprise filters/pre-sets that provide for other applications/systems to be activated/deactivated based on input from the physical sensors, and aggregation of the information by the status engine 804 (e.g., turn on the lights at home, turn up the heat in the office, etc.).

A cyber-sensing component 812, coupled with the status repository component 802, collects online information. The online information can comprise a user's social network status, and/or may comprise other user designated information. For example the user may wish to keep apprised of social status of connection, traffic, news, or other aggregated information from online services (e.g., calendars, organizers, etc.) to keep their information up-to-date.

An auto-query component 810, coupled with the status repository component 802, retrieves point-of-interest (POI) information for POIs in geographic proximity to the location of the mobile device. For example, as the mobile device is moved around a city (e.g., carried by the user) new POIs can be displayed, such as in a location hub section displayed by a user interface (UI). In this example, as the new POI is displayed a pop-up for the POI can indicate additional information, such as contact info, types of services, reviews, etc. Further, if the user selects the POI a more detailed list of info can be retrieved and displayed, for example, where the information is retrieved from the Internet 854 for the POI.

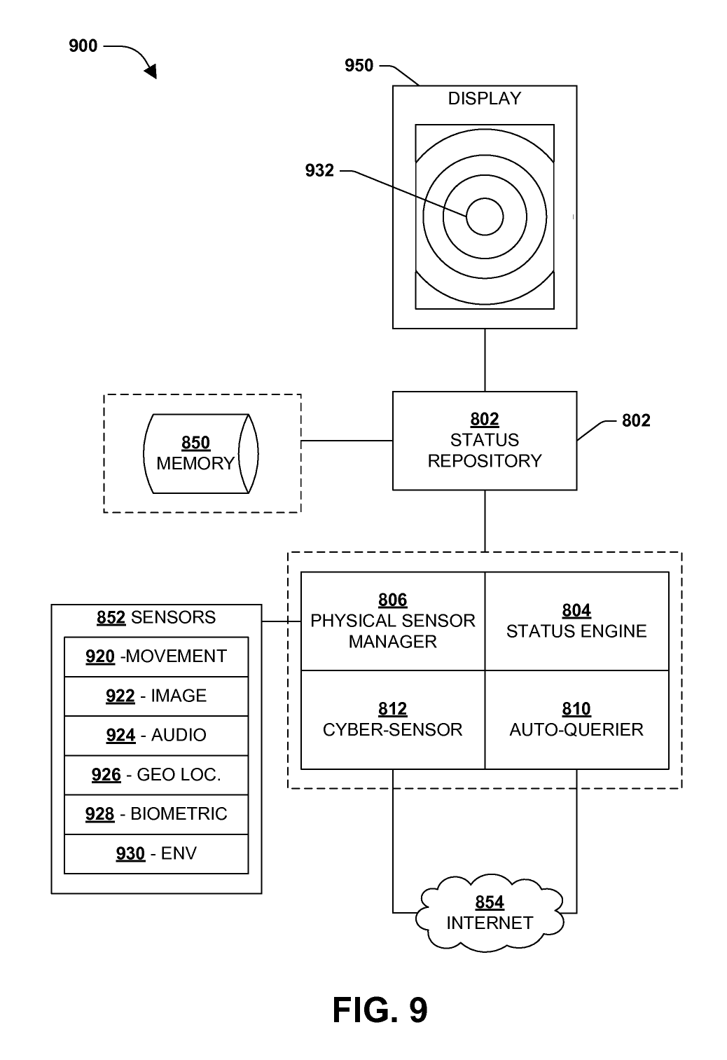

FIG. 9 illustrates one example embodiment 900 of an implementation of the systems described herein. The physical sensor management component 806 can be coupled (e.g., communicate with) a plurality of sensors 852, comprising: a movement sensor 920 (e.g., accelerometer); an image capture component 922 (e.g., camera, CMOS image sensor); an audio capture component 924 (e.g., microphone); a geographic sensing component 926 (e.g., GPS, triangulation); a biometric sensing component 928 (e.g., human biometrics, such as heart rate, temperature, EKG, etc.); and an environmental sensing component 930 (e.g., thermometer, wind, traffic, pollution, etc.).

A user interface (UI) component 932 can concurrently present a plurality of user-related status-oriented sections in a display 950 of the mobile device. As an example, two or more user-related status-oriented information sections can be displayed by the UI 932 at a same time to aggregate a plurality of status information for a user. Further, merely one of the sections can be selected, such as by the user, to display more detailed information about the particular status information section selected.

Additionally, in one embodiment, information in user-related status-oriented sections can be organized in a cylindrical representation as a cylinder, where the UI 932 presents elements of the sections in the display of the mobile device as views of the cylinder. In one embodiment, information can be organized in the cylinder such that a distance from a center of the cylinder is determined by a relationship to a user defined filter. For example, in a social hub section, information displayed closer to the center may comprise more recent social updates than those further away, as defined by the user.

In one embodiment, views of the cylinder can comprise a top-view represented by concentric circles, where respective circles comprise information represented by a common relationship. Further, views of the cylinder can comprise a side-view that comprise side panels, were a side panel comprises represented information for an individual status-related information component. Additionally, views of the cylinder can comprise a stack-view of stacked discs, where respective discs comprise information represented by a common relationship.

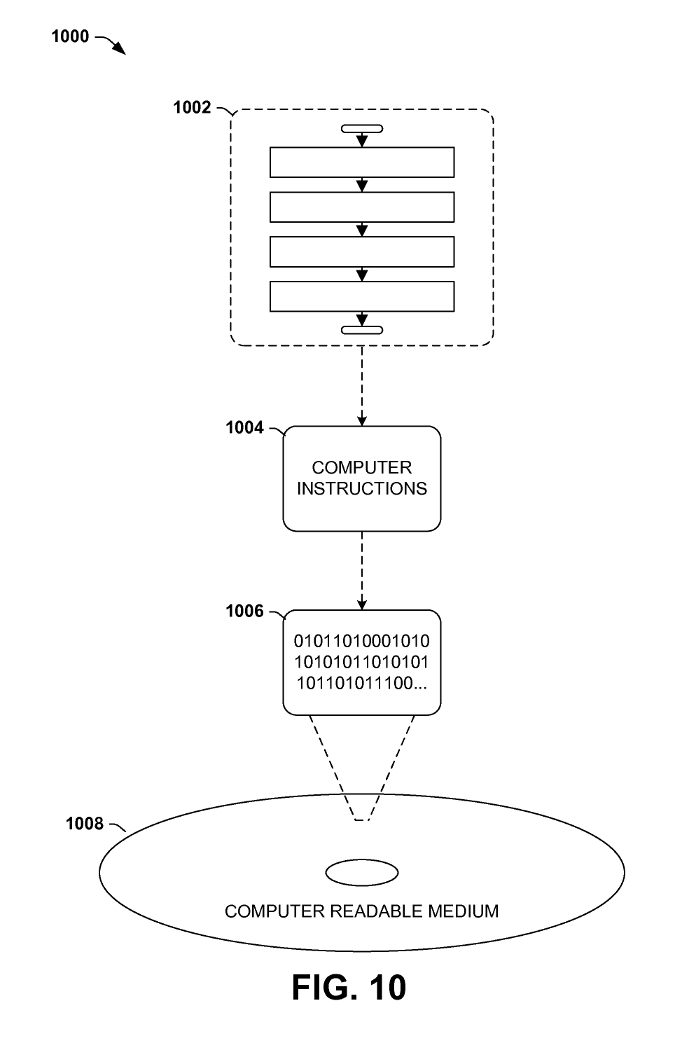

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1008 (e.g., a CD-R, DVD-R, or a platter of a hard disk drive), on which is encoded computer-readable data 1006. This computer-readable data 1006 in turn comprises a set of computer instructions 1004 configured to operate according to one or more of the principles set forth herein. In one such embodiment 1002, the processor-executable instructions 1004 may be configured to perform a method, such as the exemplary method 100 of FIG. 1, for example. In another such embodiment, the processor-executable instructions 1004 may be configured to implement a system, such as the exemplary system 800 of FIG. 8, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

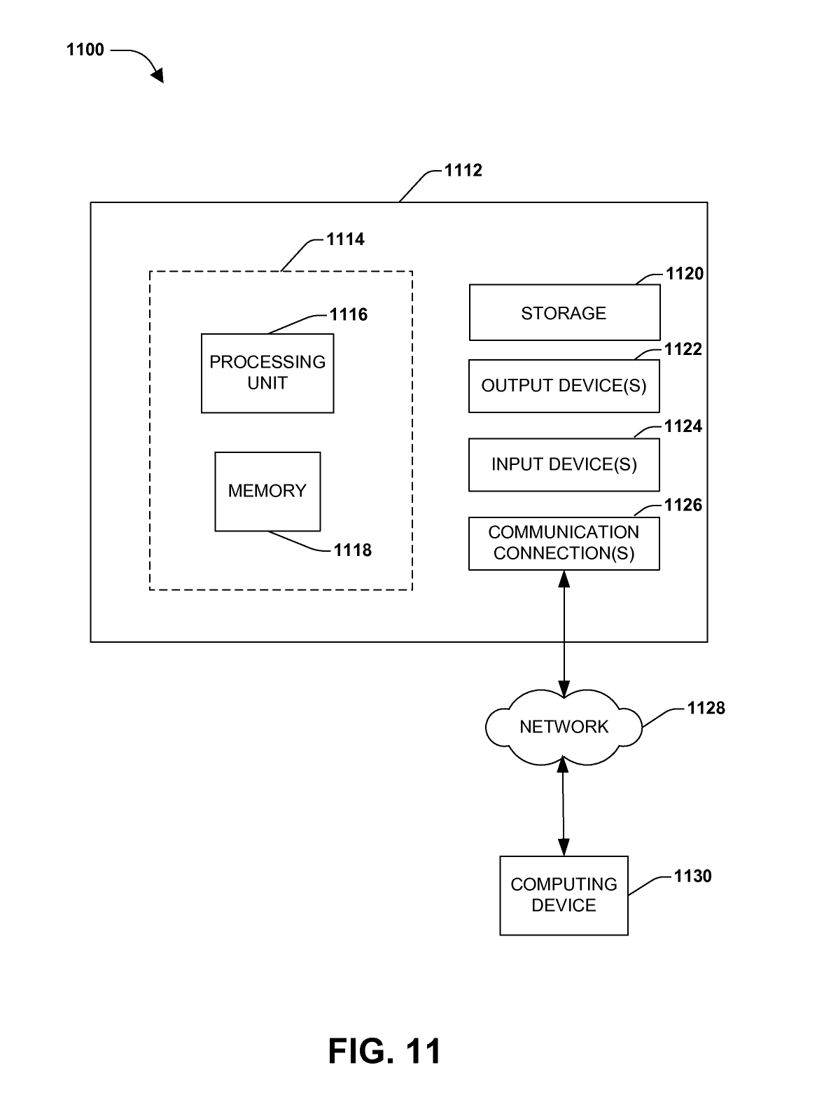

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices (e.g., including servers in the cloud), and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for providing a status-oriented mobile device, comprising:
providing for a user interface (UI) to concurrently present a plurality of user-related status-oriented sections in a display of the mobile device;
providing for the respective status-oriented sections to be organized in a cylindrical representation as a cylinder, where the UI presents elements of the sections in the display as views of the cylinder.

2. The method of claim 1, the UI presenting a location hub section that organizes user-related location status information, the presenting comprising organizing the location status information in the cylinder where a distance from a center of the cylinder represents a function of a location status information geographical distance from a user's geographic location.

3. The method of claim 2, comprising providing pre-filtered points of interest (POI) status information based on the mobile device's location, the POI information comprising one or more of:
information automatically retrieved from online for the POI when the mobile device is within a desired range of the POI; and
user filtered information for the POI.

4. The method of claim 1, the UI presenting a social hub section that organizes user-related social network status information, the presenting comprising organizing the social network status information in the cylinder where a distance from a center of the cylinder represent a function of one or more of:
a time between a last user social network update and a current time;
a closeness of a relationship between the user and a social contact;
user specified social groups; and
social networking applications.

5. The method of claim 4, comprising providing for social networks to be registered with the social hub using one or more application programming interfaces (APIs) to provide status updates in the social hub.

6. The method of claim 1, the UI presenting an event hub section that organizes user-related events status information, the presenting comprising organizing the event status information in the cylinder where a distance from center of the cylinder represents a function of time from a current time.

7. The method of claim 6, comprising providing for one or more of:
a time-based calendar systems to coordinate with the event hub;
a location-based system to coordinate with the event hub; and
a people-based system to coordinate with the event hub.

8. The method of claim 1, the UI presenting a self-status hub section that organizes user-related personal status information.

9. The method of claim 8, comprising the self hub section utilizing one or more physical sensors to determine user status information.

10. The method of claim 1, providing for the UI to present merely one of the plurality of user-related status-oriented sections in a display upon selection of the user-related status-oriented section.

11. The method of claim 1, providing for a user to select one or more desired user-related status-oriented sections to display.

12. The method of claim 11, providing for loading new user-related status-oriented sections onto the mobile device.

13. The method of claim 1, the views of the cylinder comprising one or more of a top-view comprising concentric circles, where respective circles comprise information represented by a common relationship; a side-view comprising side panels, were a side panel comprises status-related information component; and a stack-view comprising stacked discs, where respective discs comprise information represented by a common relationship.

14. A system for providing a status-oriented mobile device, comprising:
a status repository component configured to store status-related data in a memory component of the mobile device;
a status engine operably coupled with the status repository component and configured to determine a user's current status based on context of user-related status information.
a physical sensor management component operably coupled with a plurality of physical sensors and the status repository component, and configured to collect physical information from the physical sensors;
a cyber-sensing component operably coupled with the status repository component and configured to collect online information comprising:
a user's social network status; and
user designated information; and
an auto-query component operably coupled with the status repository component and configured to retrieve point-of-interest (POI) information for POIs in geographic proximity to a location of the mobile device.

15. The system of claim 14, comprising one or more of the following physical sensors:
a movement sensing component;
an image capture component;
an audio capture component;
a geographic sensing component;
a biometric sensing component; and
an environmental sensing component.

16. The system of claim 14, comprising a user interface (UI) component configured to concurrently present a plurality of user-related status-oriented sections in a display of the mobile device.

17. The system of claim 16, information in user-related status-oriented sections organized in a cylindrical representation as a cylinder, where the UI presents elements of the sections in the display of the mobile device as views of the cylinder.

18. The system of claim 17, information organized in the cylinder such that a distance from a center of the cylinder is determined by a relationship to a user defined filter.

19. The system of claim 17, views of the cylinder comprising one or more of:
a top-view comprising concentric circles, where respective circles comprise information represented by a common relationship;
a side-view comprising side panels, were a side panel comprises represented information for an individual status-related information component; and
a stack-view comprising stacked discs, where respective discs comprise information represented by a common relationship.

20. A method for providing a status-oriented mobile device, comprising:
providing for a user interface (UI) to present a plurality of user-related status-oriented sections in a display of the mobile device, the user-related status-oriented sections comprising:
a location hub that organizes user-related location status information;
a social hub that organizes user-related social network status information;
an event hub that organizes user-related events status information; and
a self-status hub that organizes user-related person status information utilizing one or more physical sensors to determine user status information; and
providing for the respective status-oriented sections to be organized in a cylindrical representation as a cylinder, where the UI presents elements of the sections in the display as views of the cylinder, comprising:
organizing the location status information in the cylinder where a distance from center of the cylinder represents a function of a location status information geographical distance from a user's geographic location;
organizing the social network status information in the cylinder where a distance from a center of the cylinder represents a function of one or more of:
a time between a last user social network update and a current time;
a closeness of a relationship between the user and a social contact;
user specified social groups; and
social networking applications; and
organizing the event status information in the cylinder where a distance from center of the cylinder represents a function of time from a current time.
